(19) United States
(12) Patent Application Publication
(10) Pub. No.: US 2026/0119230 A1
(43) Pub. Date: Apr. 30, 2026

(54) ANSIBLE PEER-TO-PEER WORK DISTRIBUTION

(71) Applicant: Red Hat, Inc., Raleigh, NC (US)

(72) Inventors: Pierre-Yves Chibon, Puteaux (FR); Adam John Miller, Austin, TX (US)

(21) Appl. No.: 18/926,034

(22) Filed: Oct. 24, 2024

(51) Int. Cl. G06F 9/48; G06F 21/60

(52) U.S. Cl. CPC G06F 9/4856; G06F 9/4881; G06F 21/602; G06F 21/606

(57) ABSTRACT

Aspects of the present disclosure relate to distribution of automation workloads via a peer-to-peer data transfer network. More specifically, a method of the present disclosure includes scheduling a unit of automation work for a target node. The method includes generating, by a processing device, a payload and an index file that corresponds to the payload and comprises information related to the payload, where the payload and the index file are associated with the unit of automation work. The method includes causing a workload associated with the unit of automation work to be migrated to the target node via a decentralized data transfer network.

### TECHNICAL FIELD

Aspects of the present disclosure relate to automation workloads, and more particularly, to distribution of automation workloads via a peer-to-peer data transfer network.

### BACKGROUND

An automation system refers to software that automates provisioning, configuration, management, application deployment, orchestration, and other processes. For instance, an automation system may eliminate and/or simplify workflows, manage and maintain system configurations, continuously deploy complex software applications, and/or perform zero-downtime rolling software updates. In an example, an automation system may be provided with a domain-specific automation file that specifies tasks to be performed to automate a process. The automation system may convert the domain-specific automation file into a payload (e.g., an executable or a script). The automation system may then perform the tasks to automate the process based on the payload. One example of an automation system is Redhat™ Ansible™ Automation software may be utilized to connect a control node and a managed node. Automation software is executed from the control node, such as a user running the automation software. Managed nodes are devices being automated such as network server.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example system in accordance with some aspects of the present disclosure.

FIG. 2 is a block diagram that illustrates distribution of automation workloads in accordance with some aspects of the present disclosure.

FIG. 3 is a block diagram that illustrates an example system in accordance with some aspects of the present disclosure.

FIG. 4 is a flow diagram of a method for distribution of automation workloads in accordance with some aspects of the present disclosure.

FIG. 5 is a block diagram of an example of a computer system that may perform one or more of the operations described herein in accordance with some aspects of the present disclosure.

### DETAILED DESCRIPTION

Automation software may be utilized on a control node to cause managed nodes to perform automated tasks. The control node may initiate a connection from the control node to the managed node. In instances where the number of managed nodes scales up to vast number of managed nodes (e.g., hundreds of thousands of managed nodes), the control node would need to correspondingly scale in a horizontal manner to accommodate the vast number of managed nodes. However, the ability to scale horizontally has constraints and limitations that may not allow for increasing the scale horizontally to accommodate the vast number of managed nodes. In some instances, a tiered method utilizing sharded groups of different managed nodes may be utilized, but the tiered method also has constraints and limitations that may not accommodate the vast number of managed nodes.

The present disclosure addresses the above-noted and other deficiencies by using a processing device to distribute automation workloads via a peer-to-peer data transfer network. In an example, the processing device schedules a unit of automation work for one or more target nodes. The processing device generates a payload and an index file that corresponds to the payload and comprises information related to the payload, where the payload and the index file are associated with the unit of automation work. The processing device causes a workload associated with the unit of automation work to be migrated to the one or more target nodes via a decentralized data transfer network.

The present disclosure provides for various technical advantages. For example, vis-à-vis generating a payload and an index file that corresponds to the payload and comprises information related to the payload, where the payload and the index file are associated with the unit of automation work and causing a workload associated with the unit of automation work to be migrated to the one or more target nodes via a decentralized data transfer network, which may conserve computing resources (e.g., memory usage, processor clock cycles, network bandwidth, etc.) by allowing the one or more target nodes to provide the workload to each other instead of each of the one or more target nodes obtaining the workload directly from a single location.

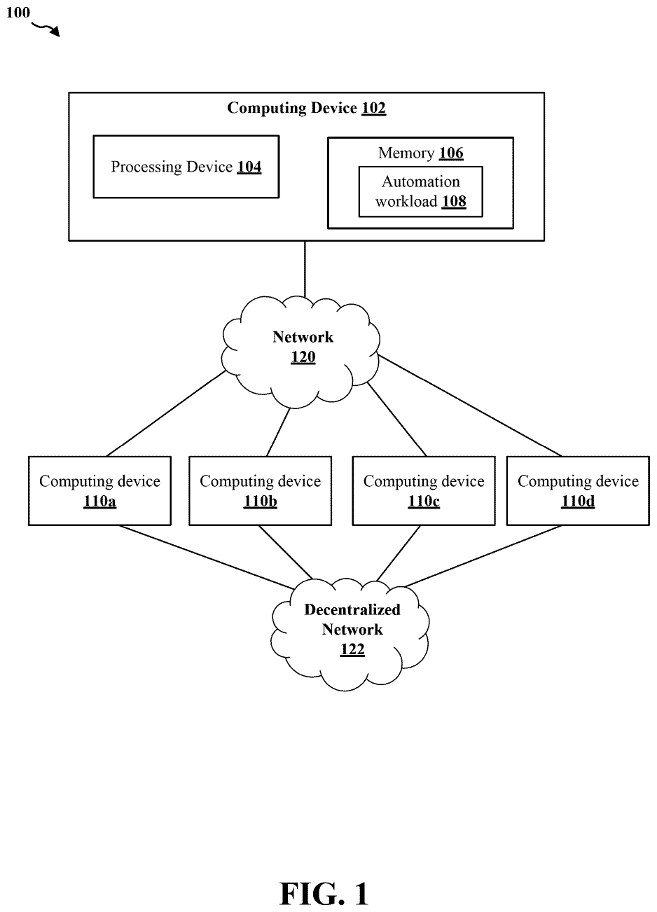

FIG. 1 is a block diagram that illustrates an example system 100 in accordance with some aspects of the present disclosure. As illustrated in FIG. 1, the system 100 includes a computing device 102, processing device 104, memory 106, and a network 120. The computing device 102 may include hardware such as a processing device 104 (e.g., processors, central processing units (CPUs)), memory 106 (e.g., random access memory (RAM), storage devices (e.g., a hard-disk drive (HDD)), and solid-state drives (SSD), etc.), and other hardware devices (e.g., a sound card, video card, etc.). A storage device may include a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The processing device 104 may be operatively coupled to the memory 106.

The computing device 102 may communicate with other devices (e.g., computing device 110a, 110b, 110c, 110d) via a network 120. The network may be a public network (e.g., the internet), a private network (e.g., a local area network (LAN) or wide area network (WAN)), or a combination thereof. In one example, the network may include a wired or a wireless infrastructure, which may be provided by one or more wireless communications systems, such as a WiFi™ hotspot connected with the network and/or a wireless carrier system that can be implemented using various data processing equipment, communication towers (e.g., cell towers), etc. The network 120 may carry communications (e.g., data, message, packets, frames, etc.) between the computing device 102 and the other devices. The computing device 102 may also include one or more sensors (e.g., temperature sensors, moisture sensors, etc.).

In some aspects, the computing device 102 may comprise any suitable type of computing device or machine that has a programmable processor (e.g., processing device 104) including, for example, server computers, desktop computers, laptop computers, tablet computers, smartphones, set-top boxes, etc. In some examples, the computing device 102 may include a single machine or may include multiple interconnected machines (e.g., multiple servers configured in a cluster). The computing device 102 may be implemented by a common entity/organization or may be implemented by different entities/organizations. The computing device 102 may execute or include an operating system (OS). The OS may manage the execution of other components (e.g., software, applications, etc.) and/or may manage access to the hardware (e.g., processors, memory, storage devices etc.) of a device in the computing device 102.

The computing device 102 may further include an automation workload 108. The automation workload 108 may include instructions for other devices (e.g., computing device 110a, 110b, 110c, 110d) to perform automated tasks. The computing device 102 may provide the automation workload to the other devices via the network 120. One or more of the other devices (e.g., computing device 110a, 110b, 110c, 110d) may be configured to distribute the automation workload 108 to the other devices (e.g., computing device 110a, 110b, 110c, 110d) via a decentralized network 122. In some aspects, the decentralized network 122 may comprise a peer-to-peer network, or the like, that allows for the other devices (e.g., computing device 110a, 110b, 110c, 110d) to communicate with each other without involvement of the computing device 102 and/or network 120. The other devices distributing the automation workload 108 using the decentralized network 122 amongst themselves allows for offloading or decreasing traffic on network 120 due in part to the computing device 102 not having to send the automation workload 108 to all the other devices (e.g., computing device 110a, 110b, 110c, 110d) via the network 120. Instead, a first other device (e.g., computing device 110a) may obtain the automation workload 108 and may allow for the remaining other devices (e.g., computing device 110b, 110c, 110d) to obtain the automation workload 108 from the first other device (e.g., computing device 110a).

The decentralized network 122 may be a peer to peer file sharing system (e.g., interplanetary file system (IPFS), bit torrent, etc.) combined with a shared data network transport without a centralized component. The devices on the decentralized network 122 may utilize a file sharing client configured to slice or partition a data file into smaller pieces where each of the pieces are indexed, provide an index file to other devices within the decentralized network to allow the other devices to obtain the pieces of the data file to reassemble the pieces to generate the data file, as well as verify the reassembled data file as a valid data file.

In some aspects, the computing device 110a may have a connection with the computing device 102 via the network 120, while other devices (e.g., computing device 110b, 110c, or 110d) may not have a connection with the computing device 102 but have a connection with the computing device 110a via the decentralized network 122. In such instances, the computing device 110a may obtain the automation workload 108 from the computing device 102 and share the automation workload 108 with other devices via the decentralized network 122.

In some aspects, multiple computing devices (e.g., 110a, 110b, 110c, 110d) may have a connection with the computing device 102 and obtain the automation workload 108 and may be configured to share the automation workload 108 with other computing devices via the decentralized network. The multiple computing devices (e.g., 110a, 110b, 110c, 110d) may share the automation workload 108 with other computing device connected to the decentralized network regardless of whether such computing devices have a connection to the computing device 102.

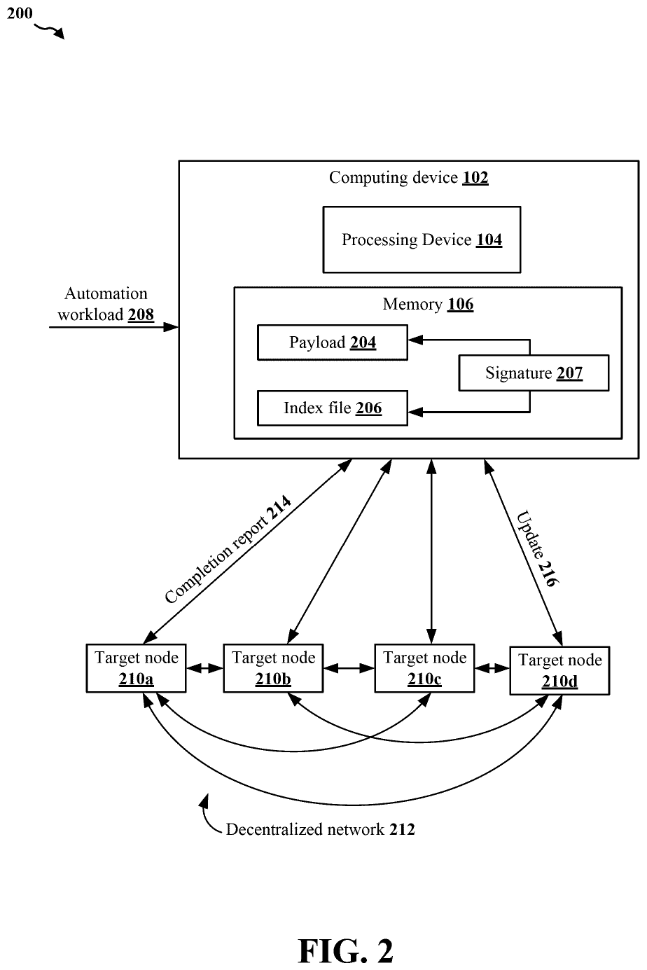

FIG. 2 is a block diagram 200 that illustrates the example system 100 of FIG. 1 in accordance with some aspects of the present disclosure. In the example depicted in FIG. 2, the computing device 102 may operate as a control node, while the target nodes 210a, 210b, 210c, 210d may be managed nodes that perform the automation. The computing device 102 may receive an automation workload 208 from an administrator (e.g., user), where the automation workload 208 includes the automation instructions. In response to receiving the automation workload 208, the computing device 102 may generate a payload 204 and an index file 206 and schedule a unit of automation work for delivery to the target nodes. The payload 204 may include the automation instructions to be performed by the devices intended to be automated (e.g., target nodes 210a, 210b, 210c, 210d). The index file 206 corresponds to the payload 204 and includes information for obtaining the payload 204.

The processing device 104, in generating the payload and the index file, may encrypt the payload 204 and index file 206. Encryption of the payload 204 and index file 206 may allow for authentication of the payload 204 and index file 206. The authentication of the payload 204 and index file 206 indicates that the payload 204 and index file 206 were in fact generated by the computing device 102. The processing device 104 may cryptographically sign both the payload 204 and the index file 206. For example, signature 207 may cryptographically sign both the payload 204 and the index file 206. In some aspects, the processing device 104 may cryptographically sign the payload 204 and the index file 206 with a private key while the target nodes may utilize a corresponding public key associated with the private key of the processing device 104 to validate the payload 204 and/or the index file 206 to authenticate the origin of the payload 204 and/or the index file 206.

In some aspects, the index file 206 may comprise a torrent file or the like, that allows for the sharing of the payload 204 amongst the target nodes. For example, a first target node 210a may obtain the index file 206 from the computing device 102. The first target node 210a may verify the cryptographic signature of the index file 206 based on the public key and then begin to obtain the payload 204. Upon obtaining the payload, the first target node 210a may seed or share the payload 204 and allow peers (e.g., target node 210b, 210c, 210d) within the decentralized network 212 to obtain the payload or a portion of the payload from the first target node 210a. When any of the peers within the decentralized network 212 obtain the payload 204, the peers may seed or share the payload 204 (or any portion of the payload) using the decentralized network 212 and allow any other peers within the decentralized network 212 to obtain the payload 204 without communicating with the computing device 102. At least an advantage of the disclosure is that the decentralized network 212 may comprise a peer-to-peer network or the like to allow for the distribution of the payload 204 amongst the target nodes 210a, 210b, 210c, 210d without having to obtain the payload 204 directly from the computing device 102 (e.g., control node). In such instances, the network transfer load is spread out over the entire sum of the decentralized network. In addition, workload on the computing device 102 (e.g., control node) may be reduced which may reduce data synchronization problems and/or database contention issues. Furthermore, distributing the payload 204 via the peer-to-peer decentralized network may increase the speed at which many different destinations of information may be obtained from a single source.

The target node 210a, 210b, 210c, 210d may be any type of computing device. In some aspects, the target nodes may comprise or be included within mobile devices, such as but not limited to mobile phones, vehicles, or other devices that are transportable. In such instances, the mobility of the target nodes may result in internet protocol (IP) changes, a change in their line of sight through a network, or a loss of connection with a central source due in part to changes in topology or the like.

In some aspects, upon completion of the unit of automation work, each of the one or more target nodes may report back to the computing device 102, the completion of the unit of automation work. For example, the first target node 210a may transmit a completion report 214 to the computing device 102, where the completion report 214 indicates that the first target node 210a has successfully completed the unit of automation work. The computing device 102, in response to receiving the completion report 214, may process the completion report 214 and/or store the results of the completion report 214. In some aspects, the first target node 210a may transmit the completion report 214 for a target node that does not have a connection with the computing device 102, where a corresponding completion report for the target node that does not have the connection with the computing device 102 is provided to the first target node 210a via the decentralized network 212.

In some aspects, the computing device 102 may provide an indication of a new or updated unit of automation work available for the one or more target nodes. For example, the computing device 102 may provide update 216 to the one or more target nodes 210a, 210b, 210c, 210d to indicate that a new or updated unit of automation work is available to be downloaded. The one or more target nodes 210a, 210b, 210c, 210d may obtain a payload associated with the new or updated unit of automation work similarly as obtaining the payload 204.

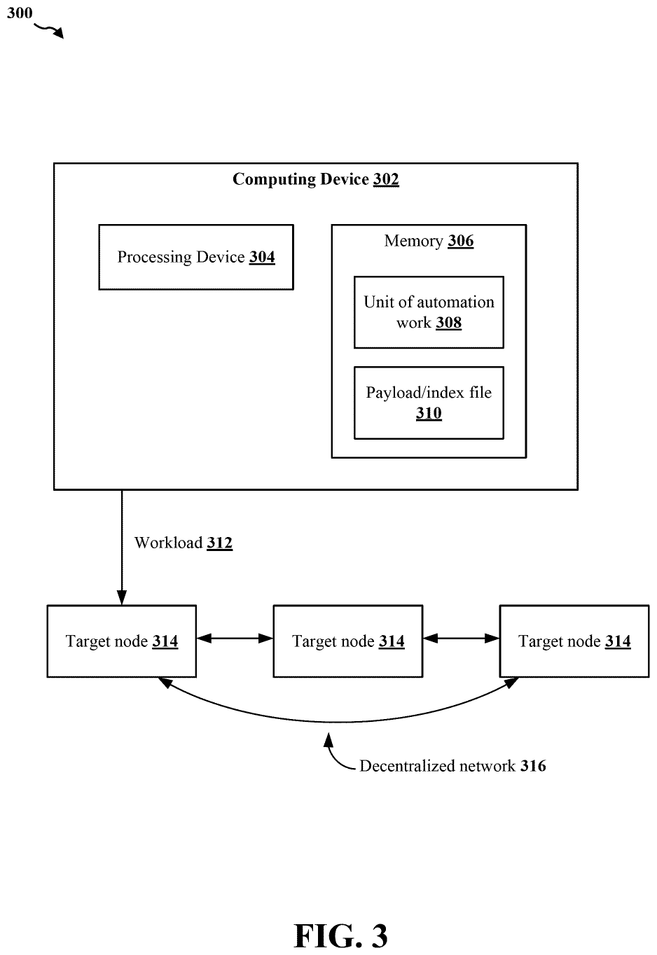

FIG. 3 is a block diagram 300 that illustrates an example system in accordance with some aspects of the present disclosure. The system includes a computing device 302. The computing device 302 includes a processing device 304 and a memory 306. The processing device 304 is operatively coupled to the memory 306.

The processing device 304 is to schedule a unit of automation work 308 for one or more target nodes 314. The processing device 304 is to generate a payload and an index file 310 that corresponds to the payload and comprises information related to the payload, where the payload and the index file are associated with the unit of automation work. The processing device 304 is to cause the workload 312 associated with unit of automation work 308 to be migrated to the one or more target nodes 314 via a decentralized data transfer network 316.

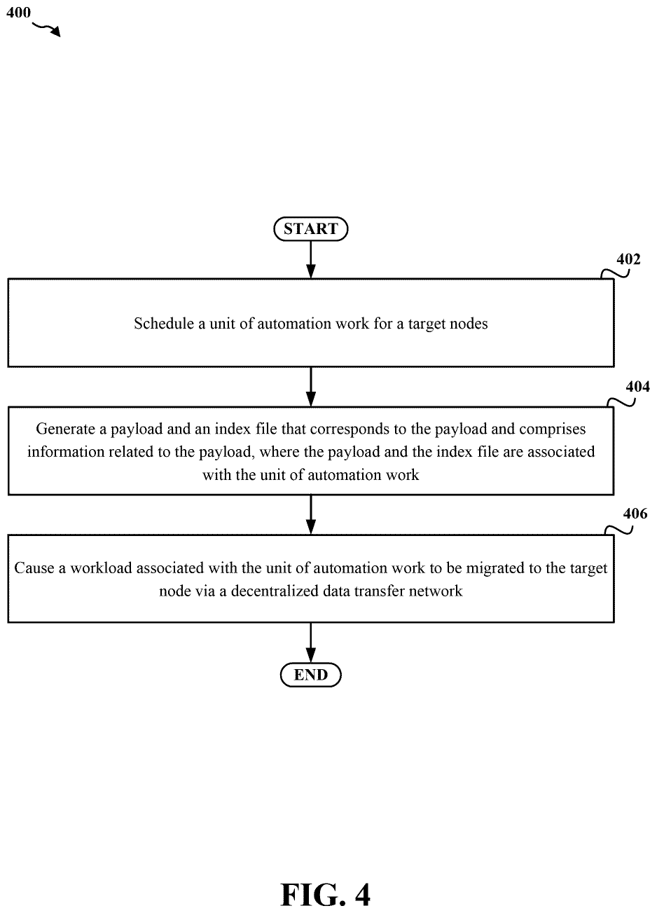

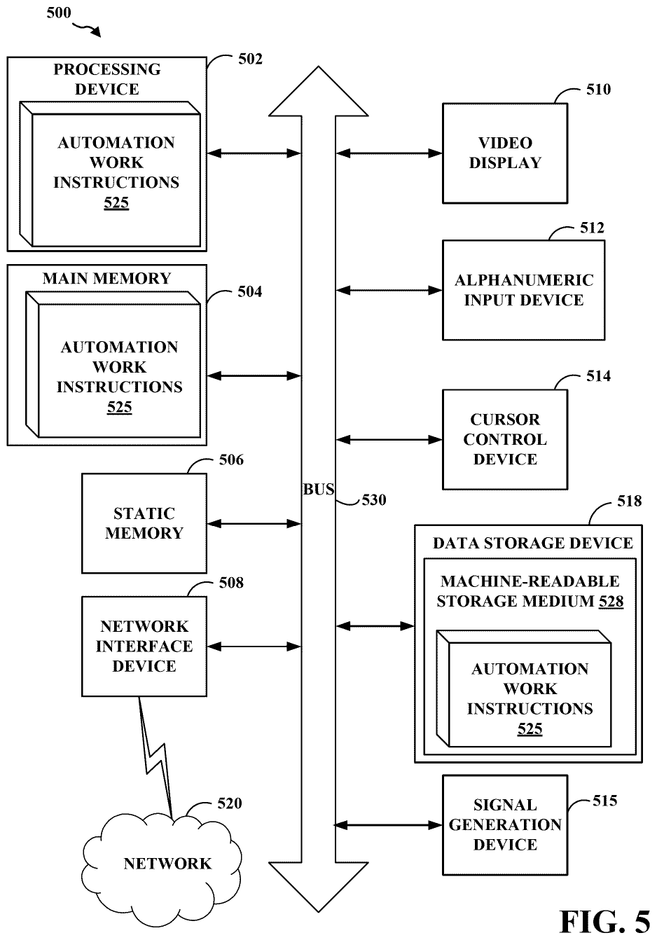

FIG. 4 is a flow diagram of a method 400 for distribution of automation workloads via a peer-to-peer data transfer network in accordance with some aspects of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 400 may be performed by a computing device (e.g., computing device 102 in FIGS. 1 and 2, a computing device 302 in FIG. 3, the computer system 500 in FIG. 5, etc.).

At block 402, a processing device schedules a unit of automation work for one or more target nodes. For example, the unit of automation work may be or include automation workload 208 or unit of automation work 308. In an example, the one or more target nodes may be or include target nodes 210a, 210b, 210c, 210d, or target node 314.

At block 404, the processing device generates a payload and an index file that corresponds to the payload and comprises information related to the payload, where the payload and the index file are associated with the unit of automation work. In an example, the payload may be or include payload 204 or payload/index file 310. In an example, the index file may be or include index file 206 or payload/index file 310.

At block 406, the processing device causes a workload associated the unit of automation work to be migrated to the one or more target nodes via a decentralized data transfer network. For example, FIG. 3 shows that a processing device may cause the workload 312 associated with the unit of automation work to be migrated to the target node 314 via a decentralized data transfer network 316.

In some aspects, generating the payload and the index file may include encrypting the payload and the index file to allow for authentication of the payload and the index file. For example, signature 207 may cryptographically sign the payload 204 and the index file 206. In another example, the payload/index file 310 may perform the cryptographically signing of the payload and the index file.

In some aspects, the processing device may initiate a decentralized data transfer network to provide the payload to the one or more target nodes. For example, the decentralized data transfer network may be or include the decentralized network 212. The decentralized data transfer network may be initiated in response to the generation of the payload and index file. In some aspects, the decentralized network 212 may be initiated by the computing device 102 with operational instructions for the target nodes (e.g., 210a, 210b, 210c, 210d) on the decentralized network 212. In some aspects, the decentralized network 212 may be initiated by a target node (e.g., 210a, 210b, 210c, 210d) on the decentralized network 212 upon receipt of the payload or a portion thereof.

In some aspects, the one or more target nodes utilize the decentralized data transfer network to obtain the payload from other target nodes within the decentralized data transfer network. For example, FIG. 2 shows the target nodes 210a-210d utilize the decentralized data transfer network to obtain the payload from other target nodes within the decentralized data transfer network.

In some aspects, the processing device may provide an update indication to the one or more target nodes to indicate that a new or updated unit of automation work is available. For example, the new or updated unit of automation work may be or include the workload 312.

FIG. 5 illustrates a diagrammatic representation of a machine in the example form of a computer system 500 within which a set of instructions, for causing the machine to perform any one or more of the methodologies discussed herein for distribution of automation workloads via a peer-to-peer data transfer network. More specifically, the machine may schedule a unit of automation work for one or more target nodes; generate a payload and an index file that corresponds to the payload and comprises information related to the payload, where the payload and the index file are associated with the unit of automation work; and cause a workload associated with the unit of automation work to be migrated to the one or more target nodes via a decentralized data transfer network.

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 500 may be representative of a server.

The computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one example, the video display unit 510, the alphanumeric input device 512, and the cursor control device 514 may be combined into a single component or device (e.g., an LCD touch screen).

The processing device 502 represents one or more general-purpose processing devices such as a microprocessor, a central processing unit, or the like. More particularly, the processing device 502 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), a network processor, or the like. The processing device 502 is configured with automation work instructions 525, for performing the operations and steps discussed herein. For example, the automation work instructions 525 may include instructions for distribution of automation workloads via a peer-to-peer data transfer network.

The data storage device 518 may include a machine-readable storage medium 528 storing automation work instructions 525 (e.g., software) embodying any one or more of the methodologies of functions described herein. The automation work instructions 525 may also reside, completely or partially, within the main memory 504 or within the processing device 502 during execution thereof by the computer system 500; the main memory 504 and the processing device 502 also constituting machine-readable storage media. The automation work instructions 525 may further be transmitted or received over the network 520 via the network interface device 508.

The machine-readable storage medium 528 may also be used to store the automation work instructions 525 to perform a method for distribution of automation workloads via a peer-to-peer data transfer network, as described herein. While the machine-readable storage medium 528 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “scheduling,” “generating,” “causing,” “encrypting,” “receiving,” “initiating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
scheduling a unit of automation work for a target node;
generating, by a processing device, a payload and an index file that corresponds to the payload and comprises information related to the payload, wherein the payload and the index file are associated with the unit of automation work; and
causing a workload associated with the unit of automation work to be migrated to the target node via a decentralized data transfer network.

2. The method of claim 1, wherein the generating the payload and the index file further comprises:
encrypting the payload and the index file to allow for authentication of the payload and the index file.

3. The method of claim 1, further comprising:
initiating the decentralized data transfer network to provide the payload to the target node.

4. The method of claim 3, wherein the decentralized data transfer network is initiated in response to the index file being authenticated.

5. The method of claim 3, wherein the target node utilizes the decentralized data transfer network to obtain the payload from other target nodes within the decentralized data transfer network.

6. The method of claim 1, further comprising:
receiving an indication of completion of the unit of automation work from the target node.

7. The method of claim 1, further comprising:
providing an update indication to the target node indicating a new unit of automation work is available.

8. A system, comprising:
a memory; and
a processing device, operatively coupled to the memory, to:
schedule a unit of automation work for a target node;
generate, by a processing device, a payload and an index file that corresponds to the payload and comprises information related to the payload, wherein the payload and the index file are associated with the unit of automation work; and
cause a workload associated with the unit of automation work to be migrated to the the target node via a decentralized data transfer network.

9. The system of claim 8, wherein to generate the payload and the index file, the processing device is to:
encrypt the payload and the index file to allow for authentication of the payload and the index file.

10. The system of claim 8, wherein the processing device is to:
initiate the decentralized data transfer network to provide the payload to the target node.

11. The system of claim 10, wherein the decentralized data transfer network is initiated in response to the index file being authenticated.

12. The system of claim 10, wherein the target node utilizes the decentralized data transfer network to obtain the payload from other target nodes within the decentralized data transfer network.

13. The system of claim 8, wherein the processing device is to:
receive an indication of completion of the unit of automation work from the target node.

14. The system of claim 8, wherein the processing device is to:
provide an update indication to the target node indicating a new unit of automation work is available.

15. A non-transitory computer-readable medium having instructions stored thereon which, when executed by a processing device, cause the processing device to:
schedule a unit of automation work for a target node;
generate, by the processing device, a payload and an index file that corresponds to the payload and comprises information related to the payload, wherein the payload and the index file are associated with the unit of automation work; and
cause a workload associated with the unit of automation work to be migrated to the target node via a decentralized data transfer network.

16. The non-transitory computer-readable medium of claim 15, wherein to generate the payload and the index file, the instructions, when executed by the processing device, cause the processing device to encrypt the payload and the index file to allow for authentication of the payload and the index file.

17. The non-transitory computer-readable medium of claim 15, wherein the instructions, when executed by the processing device, cause the processing device to initiate the decentralized data transfer network to provide the payload to the target node.

18. The non-transitory computer-readable medium of claim 15, wherein the decentralized data transfer network is initiated in response to the index file being authenticated.

19. The non-transitory computer-readable medium of claim 15, wherein the instructions, when executed by the processing device, cause the processing device to receive an indication of completion of the unit of automation work from the target node.

20. The non-transitory computer-readable medium of claim 15, wherein the instructions, when executed by the processing device, cause the processing device to provide an update indication to the target node indicating a new unit of automation work is available.
